(19) United States
(12) Patent Application Publication
(10) Pub. No.: US 2020/0367007 A1
(43) Pub. Date: Nov. 19, 2020

(54) AUDIO EFFECT CONTROL APPARATUS, AUDIO EFFECT CONTROL SYSTEM, AUDIO EFFECT CONTROL METHOD, AND PROGRAM

(71) Applicant: Sony Interactive Entertainment Inc., Tokyo (JP)

(72) Inventor: Takashi SHIMAZU, Tokyo (JP)

(73) Assignee: Sony Interactive Entertainment Inc., Tokyo (JP)

(21) Appl. No.: 16/867,900

(22) Filed: May 6, 2020

(30) Foreign Application Priority Data
May 17, 2019 (JP) 2019-093820

(51) Int. Cl. H04S 7/00; H04R 5/033; H04R 5/027

(52) U.S. Cl. CPC H04S 7/304; H04R 5/033; H04S 2400/11; H04S 2400/15; H04R 5/027

(57) ABSTRACT

Disclosed herein is an audio effect control apparatus including an effect determination section configured to determine an audio effect on the basis of a listening position or a listening direction that is changeable according to a movement of a user in a virtual space, a sound acquisition section configured to acquire a sound in an actual space, and a sound output section configured to output a sound obtained by applying the audio effect to the sound in the actual space.

### CROSS REFERENCE TO RELATED APPLICATIONS

This application claims the benefit of Japanese Priority Patent Application JP 2019-093820 filed May 17, 2019, the entire contents of which are incorporated herein by reference.

### BACKGROUND

The present disclosure relates to an audio effect control apparatus, an audio effect control system, an audio effect control method, and a program.

There exists a system, such as a game system, that can change a position and an orientation in a virtual space according to a movement of a user. With this system, the user can visually and auditorily experience a situation in the virtual space from a set position in a set orientation. By use of an acoustic rendering technology, for example, an audio effect according to the set position and orientation is applied to a sound generated in the virtual space, so that a sound field with a high sense of presence is provided to the user.

### SUMMARY

In the system described above, however, an audio effect similar to the audio effect that is applied to the sound generated in the virtual space is not applied to a sound generated in an actual space outside the system, the sound in the actual space including a voice of the user or a person nearby and a sound in the surroundings. This may cause the user to lose immersion in the virtual space.

The present disclosure has been made in view of above circumstances, and it is desirable to provide an audio effect control apparatus, an audio effect control system, an audio effect control method, and a program that can enhance the immersion of the user into the virtual space.

According to an embodiment of the present disclosure, there is provided an audio effect control apparatus including an effect determination section configured to determine an audio effect on the basis of a listening position or a listening direction that is changeable according to a movement of a user in a virtual space, a sound acquisition section configured to acquire a sound in an actual space, and a sound output section configured to output a sound obtained by applying the audio effect to the sound in the actual space.

Preferably, the sound output section outputs a sound obtained by synthesizing a sound in the virtual space and the sound obtained by applying the audio effect to the sound in the actual space.

Preferably, the audio effect control apparatus further includes closed-ear headphones including a microphone and a speaker, the microphone is disposed on an outside of the closed-ear headphones, the speaker is disposed on an inside of the closed-ear headphones, the sound acquisition section acquires a sound inputted to the microphone, and the sound output section causes the speaker to output the sound obtained by applying the audio effect to the sound in the actual space.

According to another embodiment of the present disclosure, there is provided an audio effect control system including a transmission apparatus and a reception apparatus. The transmission apparatus includes an effect determination section configured to determine an audio effect on the basis of a listening position or a listening direction that is changeable according to a movement of a user in a virtual space, an effect data generation section configured to generate effect data representing the audio effect, and a transmission section configured to transmit the effect data. The reception apparatus includes a reception section configured to receive the effect data, a sound acquisition section configured to acquire a sound in an actual space, and a sound output section configured to output a sound obtained by applying the audio effect represented by the effect data to the sound in the actual space.

Preferably, the transmission section transmits the effect data associated with an orientation of the reception apparatus, and the sound output section outputs a sound obtained by applying, on the basis of the effect data, an audio effect according to the orientation of the reception apparatus to the sound in the actual space.

Preferably, the transmission section further transmits virtual space sound data representing a sound in the virtual space, and the sound output section outputs a sound obtained by synthesizing the sound in the virtual space represented by the virtual space sound data and the sound obtained by applying the audio effect to the sound in the actual space.

Preferably, the reception apparatus further includes closed-ear headphones including a microphone and a speaker, the microphone is disposed on an outside of the closed-ear headphones, the speaker is disposed on an inside of the closed-ear headphones, the sound acquisition section acquires a sound inputted to the microphone, and the sound output section causes the speaker to output the sound obtained by applying the audio effect to the sound in the actual space.

According to a further embodiment of the present disclosure, there is provided an audio effect control apparatus including an effect determination section configured to determine an audio effect on the basis of a listening position or a listening direction that is changeable according to a movement of a user in a virtual space, an effect data generation section configured to generate effect data representing the audio effect, and a transmission section configured to transmit the effect data to an apparatus that applies the audio effect represented by the effect data to an inputted sound in an actual space.

According to a further embodiment of the present disclosure, there is provided an audio effect control method including determining an audio effect on the basis of a listening position or a listening direction that is changeable according to a movement of a user in a virtual space, acquiring a sound in an actual space, and outputting a sound obtained by applying the audio effect to the sound in the actual space.

According to a further embodiment of the present disclosure, there is provided an audio effect control method including determining an audio effect on the basis of a listening position or a listening direction that is changeable according to a movement of a user in a virtual space, generating effect data representing the audio effect, and transmitting the effect data to an apparatus that applies the audio effect represented by the effect data to an inputted sound in an actual space.

According to a further embodiment of the present disclosure, there is provided a program for a computer, including: by an effect determination section, determining an audio effect on the basis of a listening position or a listening direction that is changeable according to a movement of a user in a virtual space; by a sound acquisition section, acquiring a sound in an actual space; and by a sound output section, outputting a sound obtained by applying the audio effect to the sound in the actual space.

According to a further embodiment of the present disclosure, there is provided a program for a computer, including: by an effect determination section, determining an audio effect on the basis of a listening position or a listening direction that is changeable according to a movement of a user in a virtual space; by an effect data generation section, generating effect data representing the audio effect; and by a transmission section, transmitting the effect data to an apparatus that applies the audio effect represented by the effect data to an inputted sound in an actual space.

### BRIEF DESCRIPTION OF THE DRAWINGS

FIG. 1 is a block diagram illustrating a configuration example of an entertainment system according to an embodiment of the present disclosure;

FIG. 2 is a functional block diagram illustrating an example of functions implemented by the entertainment system according to the embodiment of the present disclosure;

FIG. 3 is a view schematically illustrating an example of determination of an audio effect according to an environment of a virtual space and generation of virtual space sound data;

FIG. 4 is a flow chart representing an example of a process performed by an entertainment apparatus according to the embodiment of the present disclosure; and

FIG. 5 is a flow chart representing an example of a process performed by a head mounted display according to the embodiment of the present disclosure.

### DETAILED DESCRIPTION OF THE PREFERRED EMBODIMENT

An embodiment of the present disclosure is hereinafter described with reference to the drawings.

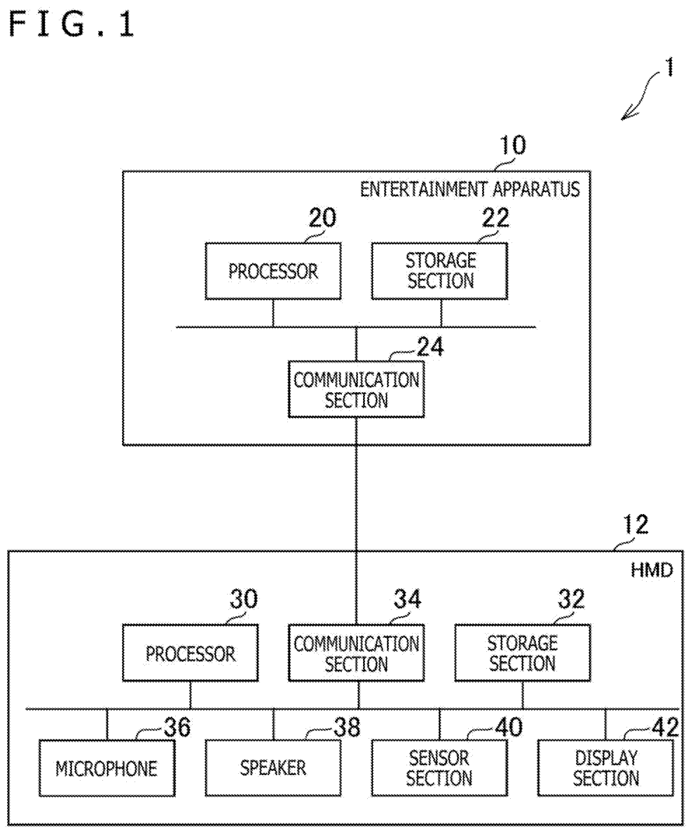

FIG. 1 is a block diagram illustrating a configuration example of an entertainment system 1 according to the embodiment of the present disclosure.

As illustrated in FIG. 1, the entertainment system 1 according to the present embodiment includes an entertainment apparatus 10 and a head mounted display (HMD) 12.

The entertainment apparatus 10 according to the present embodiment is a computer such as a game console, a digital versatile disc (DVD) player, a Blu-ray (registered trademark) player. The entertainment apparatus 10 according to the present embodiment generates a video or a sound by executing a game program or reproducing content, the game program and the content being stored in the entertainment apparatus 10 or recorded in an optical disc. The entertainment apparatus 10 according to the present embodiment, as a transmission apparatus, outputs a video signal representing a video to be generated and a sound signal representing a sound to be generated to the HMD 12 as a reception apparatus.

As illustrated in FIG. 1, the entertainment apparatus 10 according to the present embodiment includes a processor 20, a storage section 22, and a communication section 24.

The processor 20 is, for example, a program control device such as a central processing unit (CPU) that operates in accordance with a program installed in the entertainment apparatus 10. The processor 20 according to the present embodiment also includes a graphics processing unit (GPU) that draws an image in a frame buffer on the basis of a graphics command or data supplied from the CPU.

The storage section 22 is, for example, a storage device such as a read only memory (ROM) or a random access memory (RAM), or a hard disk drive. The storage section 22 stores therein a program to be executed by the processor 20 or other information. Further, the storage section 22 according to the present embodiment secures therein a region for the frame buffer in which the GPU draws an image.

The communication section 24 is, for example, a communication interface for transmitting and receiving data to and from the HMD 12 or other computers.

Further, as illustrated in FIG. 1, the HMD 12 according to the present embodiment includes a processor 30, a storage section 32, a communication section 34, a microphone 36, a speaker 38, a sensor section 40, and a display section 42.

The processor 30 is, for example, a program control device such as a CPU that operates in accordance with a program installed in the HMD 12. Further, the processor 30 according to the present embodiment includes a digital signal processor (DSP) that processes a sound signal.

The storage section 32 is, for example, a storage device such as a ROM or a RAM. The storage section 32 stores therein a program to be executed by the processor 30 or other information.

The communication section 34 is, for example, a communication interface for transmitting and receiving data to and from the entertainment apparatus 10 or other computers.

The microphone 36 is, for example, a sound input device that receives input of a sound in an actual space such as a voice of a user or a person nearby and a sound in the surroundings. Further, the microphone 36 may include an external microphone for collecting outside sounds and an internal microphone for collecting sounds outputted by the speaker 38 to an ear of the user.

The speaker 38 is, for example, a sound output device that outputs a sound to the ear of the user wearing the HMD 12.

The sensor section 40 is, for example, a sensor such as an acceleration sensor and a motion sensor. The sensor section 40 may output a result of measurement of a posture, a rotation amount, a movement amount, or the like of the HMD 12 to the processor 30 at a predetermined sampling rate.

The display section 42 is, for example, a display such as a liquid crystal display or an organic electroluminescence (EL) display and causes a video generated by the entertainment apparatus 10 or the like to be displayed. The display section 42 is disposed in front of the eyes of a user when the user wears the HMD 12. The display section 42 may receive a video signal outputted from the entertainment apparatus 10 and output a video represented by the video signal, for example. The display section 42 according to the present embodiment can cause a three-dimensional image to be displayed by, for example, displaying an image for the left eye and an image for the right eye. Note that the display section 42 may be a display section that does not display three-dimensional images but displays only two-dimensional images.

In the present embodiment, for example, the entertainment apparatus 10 executes a program such as a game program in which a position and an orientation in the virtual space (a position of a viewpoint, and an orientation of a line of sight, for example) can be changed. The user can visually and auditorily experience a situation in the virtual space from a set position in a set orientation.

For example, a moving image is generated which represents a situation in the virtual space viewed from a viewpoint disposed in the virtual space. In this case, for example, frame images are generated at a predetermined frame rate.

The position of the viewpoint and the orientation of the line of sight change according to a movement of the user such as an operation performed on a controller or a change in a position and an orientation of the HMD 12.

Alternatively, the position of the viewpoint and the orientation of the line of sight may change according to a play status of a game such as an event occurring in the game. Content displayed on the display section 42 of the HMD 12 changes in response to the change in the position of the viewpoint and the orientation of the line of sight in the virtual space. Processes according to the play status of the game, which include an update of the position of the viewpoint and the orientation of the line of sight, generation of frame images, and displaying of frame images, may be performed at a predetermined frame rate described above.

In the present embodiment, audio effects such as reverberation, echo, and delay associated with an environment of the virtual space can be applied to sounds in the actual space that are inputted to the microphone 36. Accordingly, the present embodiment can enhance the immersion of the user into the virtual space.

Further description will be made below regarding functions implemented by the entertainment system 1 according to the present embodiment and processes executed by the entertainment system 1 according to the present embodiment, especially focusing on the association between the environment of the virtual space and sounds in the actual space.

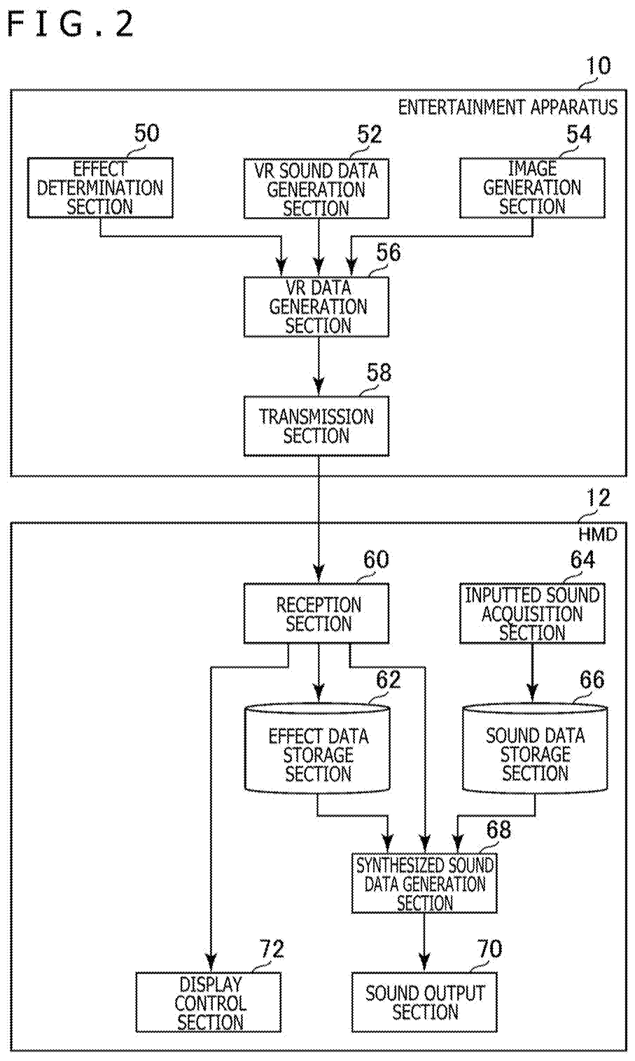

FIG. 2 is a functional block diagram illustrating an example of functions implemented by the entertainment system 1 according to the present embodiment. Note that the entertainment system 1 according to the present embodiment does not need to implement all the functions illustrated in FIG. 2 and may implement functions other than those illustrated in FIG. 2.

As illustrated in FIG. 2, the entertainment apparatus 10 according to the present embodiment functionally includes an effect determination section 50, a virtual reality (VR) sound data generation section 52, an image generation section 54, a VR data generation section 56, and a transmission section 58, for example. The effect determination section 50, the VR sound data generation section 52, the image generation section 54, and the VR data generation section 56 are implemented mainly by the processor 20. The transmission section 58 is mainly implemented by the communication section 24.

The functions mentioned above may be implemented by the processor 20 executing a program including a command corresponding to any of the functions mentioned above, the program having been installed in the entertainment apparatus 10 as a computer. This program is supplied to the entertainment apparatus 10, for example, via a computer-readable information storage medium such as an optical disc, a magnetic disk, a magnetic tape, a magneto-optical disk, and a flash memory, or via the Internet.

Further, as illustrated in FIG. 2, the HMD 12 according to the present embodiment functionally includes a reception section 60, an effect data storage section 62, an inputted sound acquisition section 64, a sound data storage section 66, a synthesized sound data generation section 68, a sound output section 70, and a display control section 72, for example. The reception section 60 is implemented mainly by the communication section 34. The effect data storage section 62 and the sound data storage section 66 are implemented mainly by the storage section 32. The inputted sound acquisition section 64 is implemented mainly by the processor 30 and the microphone 36. The synthesized sound data generation section 68 is implemented mainly by the processor 30. The sound output section 70 is implemented mainly by the processor 30 and the speaker 38. The display control section 72 is implemented mainly by the processor 30 and the display section 42.

The functions mentioned above may be implemented by the processor 30 executing a program including a command corresponding to any of the functions mentioned above, the program having been installed in the HMD 12 as a computer. This program is supplied to the HMD 12, for example, via a computer-readable information storage medium such as an optical disc, a magnetic disk, a magnetic tape, a magneto-optical disk, and a flash memory, or via the Internet.

In the present embodiment, for example, the effect determination section 50 determines an audio effect on the basis of a listening position or a listening direction that can be changed according to a movement of the user in the virtual space.

In the present embodiment, for example, the VR sound data generation section 52 generates virtual space sound data representing a sound in the virtual space.

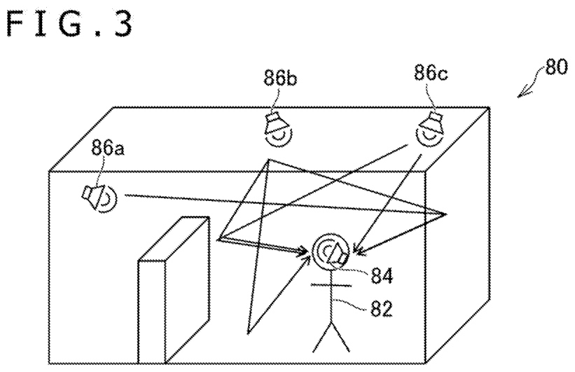

FIG. 3 is a view schematically illustrating an example of determination of an audio effect and generation of virtual space sound data.

FIG. 3 illustrates a virtual space 80 in which a character 82, a virtual character speaker 84, and virtual environment speakers 86 (86a, 86b, and 86c) exist.

In the present embodiment, for example, a position or an orientation of the character 82 in the virtual space 80 is changed according to a movement of the user. The position of the character 82 corresponds to the listening position that can be changed according to a movement of the user, and the orientation of the character 82 corresponds to the listening direction that can be changed according to a movement of the user. The effect determination section 50 determines an audio effect to be applied to a sound outputted by the virtual character speaker 84 disposed at the position of the character 82 when the sound reaches the character 82. Here, for example, by use of the acoustic rendering technology, the audio effect is determined on the basis of the environment in the virtual space 80 including virtual objects such as a wall or a ceiling, arrangement of the character 82, and the like.

Here, the effect determination section 50 may generate, for example, effect data representing values of parameters of the audio effect. As for reverberation, for example, effect data representing values of parameters such as reverberation time, pre-delay, early reflection, density, high-frequency attenuation may be generated.

Further, for example, the effect determination section 50 may determine an audio effect to be applied to a sound outputted by the virtual character speaker 84 when the sound reaches a position of the left ear of the character 82, thereby generating left effect data representing the audio effect. The effect determination section 50 may also determine an audio effect to be applied to a sound outputted by the virtual character speaker 84 when the sound reaches a position of the right ear of the character 82, thereby generating right effect data representing the audio effect. Here, the virtual character speaker 84 may be disposed at a position corresponding to the mouth of the character 82.

The effect determination section 50 does not necessarily perform the determination of an audio effect in the manner described above. For example, the effect determination section 50 may select an audio effect corresponding to the virtual space 80 in which the character 82 exists from among preset audio effects.

For example, the effect determination section 50 may store therein data associating environment attributes of the virtual space 80 with values of parameters of preset audio effects in advance. The effect determination section 50 may then generate effect data representing values of parameters associated with the environment attributes of the virtual space 80 in which the character 82 exists.

The environment attributes of the virtual space 80 here may indicate a mode of the virtual space 80 (e.g., a theater, a cave, a room, a hall, or outdoors). The environment attributes of the virtual space 80 may further indicate a size of the virtual space 80 (e.g., large, medium, and small) or a height of the ceiling of the virtual space (e.g., high, medium, and low).

In the present embodiment, for example, the virtual environment speakers 86 each output a virtual sound in the virtual space 80. The VR sound data generation section 52 then generates, for each of the virtual environment speakers 86a to 86c, virtual space sound data representing a sound heard when the virtual sound outputted by the virtual environment speaker 86 reaches the character 82. The VR sound data generation section 52 then generates virtual space sound data representing a sound obtained by synthesizing these sounds.

The sound represented by virtual space sound data is a sound with an audio effect applied, the audio effect being determined by use of the acoustic rendering technology and corresponding to the environment of the virtual space 80 including virtual objects such as a wall or a ceiling, arrangement of the character 82 and the virtual environment speakers 86, and the like.

Here, for example, the VR sound data generation section 52 may generate left virtual space sound data representing a sound heard when a virtual sound outputted by one of the virtual environment speakers 86 reaches the position of the left ear of the character 82. Further, for example, the VR sound data generation section 52 may generate right virtual space sound data representing a sound heard when a virtual sound outputted by one of the virtual environment speakers 86 reaches the position of the right ear of the character 82.

The VR sound data generation section 52 does not necessarily perform the generation of virtual space sound data in the manner described above. For example, the VR sound data generation section 52 may store therein data associating the environment attributes of the virtual space 80 with values of parameters of preset audio effects in advance. The VR sound data generation section 52 may then generate virtual space sound data representing a sound obtained by applying an audio effect associated with the environment attributes of the virtual space 80 in which the character 82 exists to a sound generated in the virtual space 80.

In the present embodiment, for example, the image generation section 54 generates frame images representing a situation in the virtual space 80 viewed from a viewpoint of the character 82 disposed in the virtual space 80.

In the present embodiment, for example, the VR data generation section 56 generates VR data including the effect data, the virtual space sound data, and the frame images. Here, for example, the effect data may include left effect data and right effect data. Further, the virtual space sound data may include left virtual space sound data and right virtual space sound data.

In the present embodiment, for example, the transmission section 58 transmits the VR data described above to the HMD 12.

In the present embodiment, for example, the reception section 60 receives the VR data described above from the entertainment apparatus 10.

In the present embodiment, for example, the effect data storage section 62 stores therein effect data representing an audio effect to be applied to an inputted sound in the actual space. Here, for example, the reception section 60 may cause the effect data storage section 62 to store the effect data included in the received VR data. In this instance, effect data stored in the effect data storage section 62 may be overwritten.

In the present embodiment, for example, the inputted sound acquisition section 64 acquires inputted sound data representing an inputted sound in the actual space. Here, for example, inputted sound data representing a sound in the actual space inputted to the microphone 36 is acquired.

In the present embodiment, for example, the sound data storage section 66 stores therein the inputted sound data. The inputted sound data stored in the sound data storage section 66 is, for example, used to generate early reflections and reverberations.

In the present embodiment, for example, the synthesized sound data generation section 68 generates a sound by applying, to the inputted sound in the actual space, the audio effect represented by the effect data stored in the effect data storage section 62. Further, in the present embodiment, for example, the synthesized sound data generation section 68 synthesizes the sound in the actual space with the audio effect applied and the sound represented by the virtual space sound data, thereby generating synthesized sound data representing a sound obtained as a result of the synthesis.

Here, for example, the synthesized sound data generation section 68 may generate left synthesized sound data by synthesizing a sound obtained by applying the audio effect represented by the left effect data to the sound in the actual space and a sound represented by the left virtual space sound data. Further, the synthesized sound data generation section 68 may generate right synthesized sound data by synthesizing a sound obtained by applying the audio effect represented by the right effect data to the sound in the actual space and a sound represented by the right virtual space sound data.

In the present embodiment, for example, the sound output section 70 outputs the sound obtained by applying the audio effect represented by the effect data stored in the effect data storage section 62 to the inputted sound in the actual space. Here, the sound output section 70 may output a sound obtained by synthesizing this sound and the sound in the virtual space 80 represented by the virtual space sound data. For example, the sound output section 70 may output the sound represented by the synthesized sound data generated by the synthesized sound data generation section 68. In the present embodiment, the sound output section 70 causes the speaker 38 to output the sound.

Here, for example, the sound represented by the left synthesized sound data may be outputted from a speaker 38 configured to output sounds to the left ear of the user, and the sound represented by the right synthesized sound data may be outputted from another speaker 38 configured to output sounds to the right ear of the user.

In the present embodiment, for example, the display control section 72 causes the display section 42 to display the frame images included in the VR data received by the reception section 60.

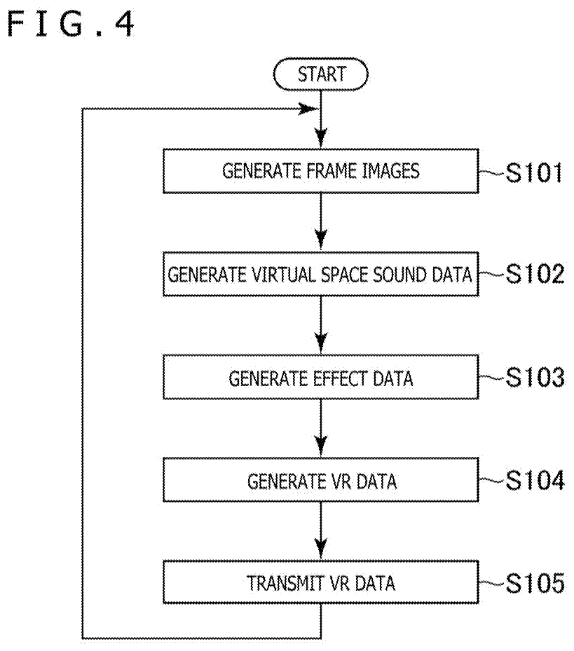

Here, an example of flow of a process performed by the entertainment apparatus 10 according to the present embodiment is described with reference to a flow chart illustrated in FIG. 4. In this process example, processing steps in S101 to S105 of FIG. 4 are repeated at a predetermined frame rate.

First, the image generation section 54 generates frame images representing the situation in the virtual space 80 viewed from the position of the character 82 in a frame (S101).

The VR sound data generation section 52 then generates virtual space sound data on the basis of the environment in the virtual space 80 in the frame (S102).

The effect determination section 50 then generates effect data on the basis of the environment in the virtual space 80 in the frame (S103).

The VR data generation section 56 then generates VR data including the frame images generated by the processing step in S101, the virtual space sound data generated by the processing step in S102, and the effect data generated by the processing step in S103 (S104).

The transmission section 58 then transmits the VR data generated by the processing step in S104 to the HMD 12 (S105), and the process returns to the processing step in S101.

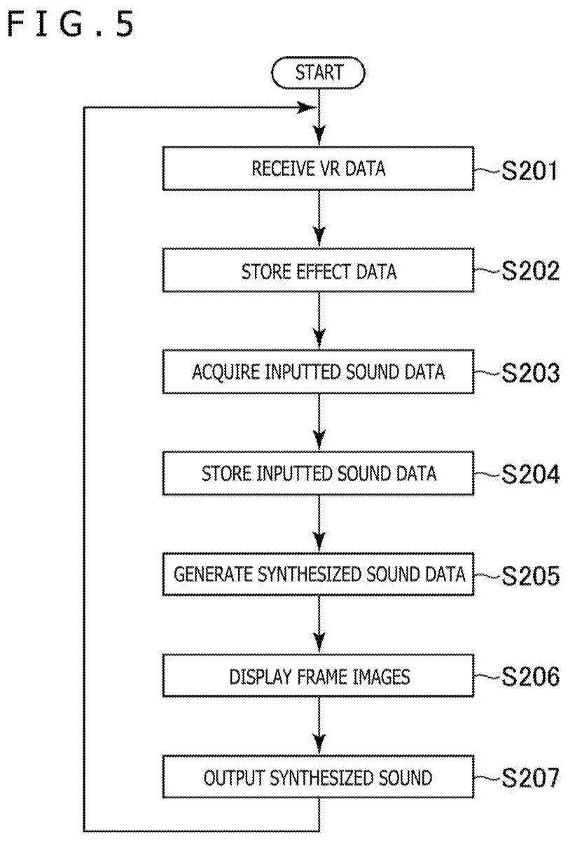

Next, an example of flow of a process performed by the HMD 12 according to the present embodiment is described with reference to a flow chart illustrated in FIG. 5. In this process example, processing steps in S201 to S207 of FIG. 5 are repeated at a predetermined frame rate.

First, the reception section 60 receives the VR data in the frame, the VR data having been transmitted by the processing step in S105 (S201).

The reception section 60 then causes the effect data storage section 62 to store the effect data in the frame included in the VR data received by the processing step in S201 (S202).

The inputted sound acquisition section 64 then acquires inputted sound data representing a sound inputted from the microphone 36 in the frame (S203).

The inputted sound acquisition section 64 then causes the sound data storage section 66 to store the inputted sound data acquired by the processing step in S203 (S204).

The synthesized sound data generation section 68 then generates synthesized sound data in the frame (S205). Here, for example, actual space sound data is generated which represents a sound obtained by applying an audio effect represented by the effect data in the frame stored by the processing step in S202 to the sound represented by the inputted sound data acquired by the processing step in S203. In this instance, the inputted sound data stored in the sound data storage section 66 may be used. Then, synthesized sound data is generated which represents a sound obtained by synthesizing the sound represented by the actual space sound data and a sound represented by the virtual space sound data included in the VR data received by the processing step in S201.

The display control section 72 then causes the display section 42 to display the frame images included in the VR data received by the processing step in S201 (S206).

The sound output section 70 then outputs the sound represented by the synthesized sound data generated by the processing step in S205 from the speaker 38 (S207), and the process returns to the processing step in S201.

In the present embodiment, an audio effect associated with the environment of the virtual space is applied to a sound in the actual space inputted from the microphone 36 in the manner described above. According to the present embodiment, the immersion of the user into the virtual space can thus be enhanced.

Further, in the present embodiment, an audio effect associated with the environment of the virtual space is applied to a sound in the actual space inputted from the microphone 36 without transmitting the sound to the entertainment apparatus 10. Hence, according to the present embodiment, the audio effect associated with the environment of the virtual space can be applied to the inputted sound in the actual space in a short period of time.

Alternatively, the entertainment system 1 may be configured such that, only in a case where the environment attributes of the virtual space change, effect data is transmitted from the entertainment apparatus 10 to the HMD 12. The HMD 12 may replace, in response to the reception of the effect data, the effect data stored in the effect data storage section 62 with the received effect data for updating.

Further, in the present embodiment, displaying of frame images and outputting of sounds may be performed in a synchronous or asynchronous manner.

In a case where the environment attributes of the virtual space do not change, for example, the entertainment apparatus 10 may transmit VR data including no effect data. Then, the HMD 12 may be configured such that, only in a case where the received VR data includes effect data, the effect data stored in the effect data storage section 62 is replaced with the received effect data for updating.

The configuration described above is preferable, for example, in a case where an audio effect to be applied to a sound in the actual space is changed following a change in the environment attributes of the virtual space where the character exists. For example, it is preferable in a case where the mode of the virtual space where the character exists is changed from “outdoors” to “in a cave” and, following this change, the audio effect to be applied to the inputted sound in the actual space is changed from one corresponding to “outdoors” to another corresponding to “in a cave.”

The configuration described above can also reduce an amount of data transmitted from the entertainment apparatus 10 to the HMD 12.

Further, in a case where the orientation of the HMD 12 in the actual space coincides with the orientation of the character in the virtual space, for example, the effect determination section 50 may generate effect data associated with the orientation of the HMD 12. For example, the effect data may be data including as a parameter an angle defined between a predetermined orientation and the orientation of the HMD 12.

Alternatively, the effect data may be data representing a plurality of values associated with respective angles defined between the predetermined orientation and the orientation of the HMD 12.

The synthesized sound data generation section 68 may determine an audio effect to be applied on the basis of the effect data included in the VR data received by the reception section 60 and the orientation of the HMD 12 measured by the sensor section 40. The synthesized sound data generation section 68 may then apply the determined audio effect to a sound in the actual space. The sound applied with the audio effect in this manner may be outputted from the speaker 38. In this instance, the orientation of the character in the virtual space may change according to a change in the orientation of the HMD 12 measured by the sensor section 40.

Here, it is also possible to configure the entertainment system 1 such that, in a case where the environment attributes of the virtual space do not change even if the orientation of the character changes in association with the change in the orientation of the HMD 12, effect data is not transmitted from the entertainment apparatus 10 to the HMD 12. In this case, for example, the entertainment apparatus 10 may transmit VR data including no effect data. This can reduce the amount of data transmitted from the entertainment apparatus 10 to the HMD 12.

Further, in the present embodiment, the HMD 12 may include headphones. The headphones may have the microphone 36 and the speaker 38 mounted therein.

Further, in the present embodiment, a direct sound inputted from the microphone 36 is outputted from the speaker 38. Note that, in a case where the HMD 12 includes open-air headphones and the direct sound reaches an ear of the user, the direct sound inputted from the microphone 36 may not be necessarily outputted from the speaker 38. In this instance, the speaker 38 may output only a sound obtained by applying an audio effect to the direct sound inputted from the microphone 36 (e.g., early reflections and reverberations).

Alternatively, the HMD 12 may include closed-ear headphones, for example. The closed-ear headphones may have the speaker 38 mounted on an inside thereof (on a side of the ears), and the microphone 36 mounted on an outside thereof.

Further, the microphone 36 may be disposed near an ear of the user wearing the HMD 12.

Further, for example, the synthesized sound data generation section 68 may generate a sound signal by subtracting a sound signal of a sound represented by the virtual space sound data from a sound signal of a sound in the actual space inputted from the microphone 36. The synthesized sound data generation section 68 may then generate a sound by applying, to the sound represented by the generated sound signal, an audio effect represented by the effect data stored in the effect data storage section 62. This can prevent an audio effect from being applied to the sound represented by the virtual space sound data existing mixedly in the sound in the actual space inputted from the microphone 36.

Note that the present disclosure is not limited to the embodiment described above.

For example, allocation of functions between the entertainment apparatus 10 and the HMD 12 is not limited to that described above. For example, some or all of the functions of the entertainment apparatus 10 may be implemented by the HMD 12. For example, the HMD 12 may perform all of the following functions: determination of an audio effect, acquisition of a sound in the actual space, and outputting of a sound obtained by applying the audio effect to the sound in the actual space.

Further, for example, data representing the environment attributes of the virtual space may be transmitted from the entertainment apparatus 10 to the HMD 12. The HMD 12 may then determine an audio effect according to the environment of the virtual space on the basis of the data representing the environment attributes of the virtual space. The HMD 12 may then apply the determined audio effect to the inputted sound in the actual space.

The microphone 36 may not be necessarily mounted in the HMD 12. The microphone 36 may include a plurality of microphones (a microphone array).

The HMD 12 according to the present embodiment may not necessarily receive effect data from the entertainment apparatus 10 existing near the HMD 12. For example, the HMD 12 may receive effect data from a cloud service.

The apparatus that applies an audio effect according to the environment of the virtual space to an inputted sound in the actual space may not be necessarily the HMD 12.

It should be understood by those skilled in the art that various modifications, combinations, sub-combinations and alterations may occur depending on design requirements and other factors insofar as they are within the scope of the appended claims or the equivalents thereof.

What is claimed is:

1. An audio effect control apparatus comprising:
an effect determination section configured to determine an audio effect on a basis of a listening position or a listening direction that is changeable according to a movement of a user in a virtual space;
a sound acquisition section configured to acquire a sound in an actual space; and
a sound output section configured to output a sound obtained by applying the audio effect to the sound in the actual space.

2. The audio effect control apparatus according to claim 1, wherein
the sound output section outputs a sound obtained by synthesizing a sound in the virtual space and the sound obtained by applying the audio effect to the sound in the actual space.

3. The audio effect control apparatus according to claim 1, further comprising:
closed-ear headphones including a microphone and a speaker, wherein
the microphone is disposed on an outside of the closed-ear headphones,
the speaker is disposed on an inside of the closed-ear headphones,
the sound acquisition section acquires a sound inputted to the microphone, and
the sound output section causes the speaker to output the sound obtained by applying the audio effect to the sound in the actual space.

4. An audio effect control system comprising:
a transmission apparatus including
an effect determination section configured to determine an audio effect on a basis of a listening position or a listening direction that is changeable according to a movement of a user in a virtual space,
an effect data generation section configured to generate effect data representing the audio effect, and a transmission section configured to transmit the effect data; and
a reception apparatus including
a reception section configured to receive the effect data,
a sound acquisition section configured to acquire a sound in an actual space, and
a sound output section configured to output a sound obtained by applying the audio effect represented by the effect data to the sound in the actual space.

5. The audio effect control system according to claim 4, wherein
the transmission section transmits the effect data associated with an orientation of the reception apparatus, and
the sound output section outputs a sound obtained by applying, on a basis of the effect data, an audio effect according to the orientation of the reception apparatus to the sound in the actual space.

6. The audio effect control system according to claim 4, wherein
the transmission section further transmits virtual space sound data representing a sound in the virtual space, and
the sound output section outputs a sound obtained by synthesizing the sound in the virtual space represented by the virtual space sound data and the sound obtained by applying the audio effect to the sound in the actual space.

7. The audio effect control system according to claim 4, wherein
the reception apparatus further includes closed-ear headphones including a microphone and a speaker,
the microphone is disposed on an outside of the closed-ear headphones,
the speaker is disposed on an inside of the closed-ear headphones,
the sound acquisition section acquires a sound inputted to the microphone, and
the sound output section causes the speaker to output the sound obtained by applying the audio effect to the sound in the actual space.

8. An audio effect control apparatus comprising:
an effect determination section configured to determine an audio effect on a basis of a listening position or a listening direction that is changeable according to a movement of a user in a virtual space;
an effect data generation section configured to generate effect data representing the audio effect; and
a transmission section configured to transmit the effect data to an apparatus that applies the audio effect represented by the effect data to an inputted sound in an actual space.

9. An audio effect control method comprising:
determining an audio effect on a basis of a listening position or a listening direction that is changeable according to a movement of a user in a virtual space;
acquiring a sound in an actual space; and
outputting a sound obtained by applying the audio effect to the sound in the actual space.

10. An audio effect control method comprising:
determining an audio effect on a basis of a listening position or a listening direction that is changeable according to a movement of a user in a virtual space;
generating effect data representing the audio effect; and
transmitting the effect data to an apparatus that applies the audio effect represented by the effect data to an inputted sound in an actual space.
